(19) United States
(12) Patent Application Publication
(10) Pub. No.: US 2017/0124430 A1
(43) Pub. Date: May 4, 2017

(54) APPARATUS, METHOD AND PROGRAM FOR CLASSIFYING CROWD

(71) Applicant: Kabushiki Kaisha Toshiba, Tokyo (JP)

(72) Inventors: Hidetaka OHIRA, Saiwai-ku Kawasaki Kanagawa (JP); Yuto YAMAJI, Saiwai-ku Kawasaki Kanagawa (JP); Shihomi TAKAHASHI, Kanagawa-ku Yokohama Kanagawa (JP); Tomoyuki SHIBATA, Miyamae-ku Kawasaki Kanagawa (JP); Osamu YAMAGUCHI, Aoba-ku Yokohama Kanagawa (JP)

(21) Appl. No.: 15/263,790

(22) Filed: Sep. 13, 2016

(30) Foreign Application Priority Data
Nov. 2, 2015 (JP) 2015-215816

(51) Int. Cl. G06K 9/62; G06T 7/00; G06K 9/46; G06K 9/00

(52) U.S. Cl. CPC G06K 9/6267; G06K 9/00778; G06T 7/0081; G06K 9/6218; G06K 9/4604; G06K 9/00228

(57) ABSTRACT

Disclosed is an apparatus for classifying crowd. The apparatus is configured to: acquire a time-series image including the crowd; divide the image into a plurality of regions and calculate a stay degree for each of the regions from a number of persons in one of the regions and size and direction of motion of persons in one of the regions, wherein the stay degree has a higher value for more stopping persons in one of the regions; and classify each of the regions according to the stay degree as one of an attribute indicating that the crowd are stopping in the region, an attribute indicating that the crowd are moving in the region and an attribute indicating that no crowd exist in the region. The apparatus is configured to: set a range occupied by one or more regions having the same attribute as one block and display the block while expressing the attribute.

### CROSS-REFERENCE TO RELATED APPLICATIONS

This application is based upon and claims the benefit of priority from the prior Japanese Patent Application No. 2015-215816, filed on Nov. 2, 2015; the entire contents of which are incorporated herein by reference.

### FIELD

Embodiments described herein relate to an apparatus, method and program for classifying crowd.

### BACKGROUND

It has been conventionally determined whether or not a visitor of an exhibition is staying based on the number of flow lines (movement lines) obtained by tracking persons in an image obtained by photographing the rooms in the exhibition.

An exhibition may have various visitors (crowd) having different attributes, including visitors who have stopped to appreciate exhibits, visitors who are just moving by exhibits, etc. However, there is a problem in that it is difficult to grasp the attributes of crowd.

To overcome the above problem, it is, therefore, an object of an embodiment of the present invention to provide an apparatus, method and program for classifying crowd, which is capable of grasping the attributes of crowd.

### BRIEF DESCRIPTION OF THE DRAWINGS

FIG. 1 is a block diagram illustrating a crowd classifying apparatus according to a first embodiment;

FIG. 2 is a flow chart illustrating a process of the crowd classifying apparatus;

FIG. 3 is an explanatory view illustrating a stay degree for each region;

FIGS. 4A and 4B present an explanatory view of a first classifying method of a classification unit;

FIGS. 5A, 5B, and 5C present an explanatory view of a third classifying method of the classification unit;

FIG. 6 is an explanatory view of a fourth classifying method of the classification unit;

FIGS. 7A and 7B present an explanatory view of a third example of a block;

FIGS. 8A and 8B present an explanatory view of a fourth example of the block;

FIGS. 9A, 9B, and 9C present an explanatory view illustrating a method of displaying a second example of a display unit;

FIGS. 10A and 10B is an explanatory view illustrating a method of displaying a third example of the display unit;

FIG. 11 is a block diagram illustrating a crowd classifying apparatus according to a second embodiment;

FIG. 12A is an explanatory view of block division of the classification unit and FIGS. 12B and 12C are explanatory views of a first example of the display unit;

FIGS. 13A and 13B present an explanatory view of the second example of the display unit;

FIGS. 14A, 14B, and 14C present an explanatory view of a fourth example of the display unit; and

FIG. 15 is a block diagram illustrating an example of the hardware configuration of a crowd classifying apparatus.

### DETAILED DESCRIPTION

According to one embodiment, there is provided an apparatus for classifying crowd, including: processing circuitry and a display. The processing circuitry is configured to: acquire a time-series image including crowd; divide the image into a plurality of regions and calculate a stay degree for each of the regions from a number of persons in one of the regions and the size and direction of motion of persons in one of the regions, wherein the stay degree has a higher value for more stopping persons in one of the regions; and classify each of the regions according to the stay degree as one of an attribute indicating that the crowd are stopping in the region, an attribute indicating that the crowd are moving in the region and an attribute indicating that no crowd exists in the region. The display is configured to: set a range occupied by one or more regions having a same attribute as one block and display the block while expressing the attribute.

Hereinafter, a crowd classifying apparatus 10 of one embodiment of the present invention will be described with reference to the drawings.

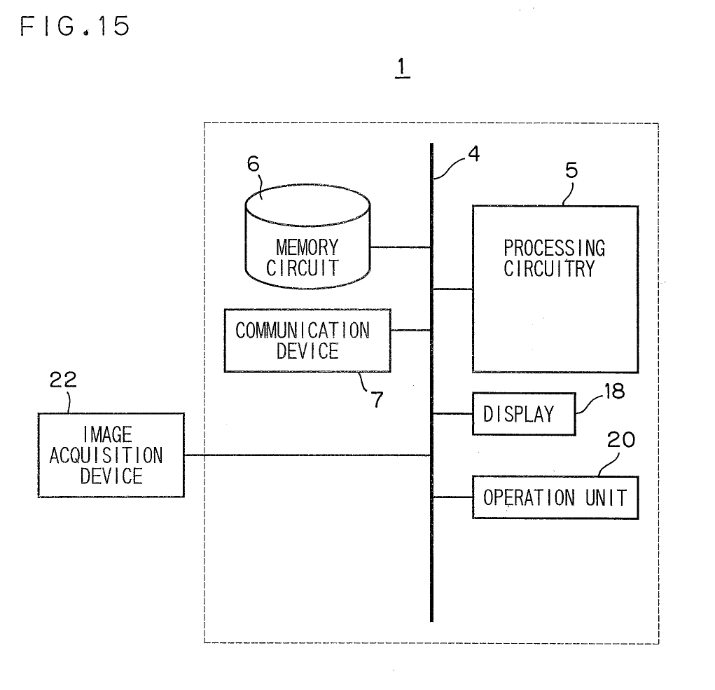

A crowd classifying apparatus 10 of the embodiment is, for example, a dedicated or general-purpose computer, as illustrated in FIG. 15. The crowd classifying apparatus 10 includes a bus 4 connecting a processing circuitry 5, a memory circuit 6, a communication device 7, a display 18, an operation unit 20 and an image acquisition device 22.

The processing circuitry 5 includes an acquisition unit 12, a stay degree calculation unit 14 and a classification unit 16, as described above. Although the function related to the present embodiment has been mainly illustrated in the example of FIG. 15, the respective units included in the processing circuitry 5 are not limited thereto. The function of each of the respective units will be described in detail later.

The function of each unit performed in the crowd classifying apparatus 10 is stored in the memory circuit 6 in the form of a computer-executable program. The processing circuitry 5 is a processor for reading and executing a program from the memory circuit 6 to implement a function corresponding to the program. The processing circuitry 5 in a state of reading each program has the function of each unit illustrated in the processing circuitry 5 of FIG. 15. Although it is illustrated in FIG. 15 that the functions performed in the acquisition unit 12, the stay degree calculation unit 14 and the classification unit 16 are implemented in a single processing circuitry 5, these functions may be implemented by constructing the processing circuitry 5 in combination of plural independent processors and causing the processors to execute their respective programs. Each processing function may be configured as a program, a single processing circuitry 5 may execute each program, or a specified function may be installed in a dedicated independent program executing circuit.

The acquisition unit 12, the stay degree calculation unit 14 and the classification unit 16 included in the processing circuitry 5 are examples of an acquisition module, a stay degree calculation module and a classification module, respectively.

The term “processor” used in the above description refers to one of, e.g., a central processing unit (CPU), a graphical processing unit (GPU), an application specific integrated circuit (ASIC) and a programmable logic device (e.g., a simple programmable logic device (SPLD), a complex programmable logic device (CPLD) or a field programmable gate array (FPGA)). The processor implements a function by reading and executing a program stored in the memory circuit 6. Instead of being stored in the memory circuit 6, the program may be directly inserted in a circuit of the processor. In this case, the processor implements the function by reading and executing the program inserted in the circuit of the processor.

The memory circuit 6 stores data (e.g., images, stay degrees, etc.) and the like associated with the functions of the respective units performed by the processing circuitry 5, as necessary. The memory circuit 6 stores programs of the functions of the respective units. For example, the memory circuit 6 is a semiconductor memory device such as a random access memory (RAM), a flash memory or the like, a hard disk, an optical disc, or the like. A process performed by the memory circuit 6 in the processing circuitry 5 may be replaced with an external storage device of the crowd classifying apparatus 10. The memory circuit 6 may be a storage medium which downloads and stores or temporarily stores a program transmitted via a local area network (LAN), the Internet or the like. The storage medium is not limited to a single form. The storage medium of the embodiment may include even plural media from which the process in the above-described embodiment is executed. The storage medium may have any configuration.

The communication device 7 is an interface for exchanging information with an external device connected by a wire or wirelessly. The communication device 7 may conduct communication in access to a network.

The operation unit 20 receives a variety of instructions or input information related to the crowd classifying apparatus 10 from an operator.

The display 18 displays a variety of information related to the crowd classifying apparatus 10. The display 18 is a display device such as, e.g., a liquid crystal display device.

In the present embodiment, the operation unit 20 and the display 18 are connected to the crowd classifying apparatus 10 by a wire or wirelessly. The operation unit 20 and the display 18 may be connected to the crowd classifying apparatus 10 via a network.

In one embodiment, a computer or an insertion system is provided to execute each process in the embodiment based on a program stored in a storage medium, and may be a single device such as a personal computer or a microcomputer, or alternatively may be any configuration such as a system including plural devices connected to a network.

The term “computer” in the embodiment is not limited to a personal computer but may refer generally to devices and apparatuses capable of realizing the functions in the embodiment by a program, including an arithmetic processing device included in an information processing apparatus, a microcomputer, etc.

### First Embodiment

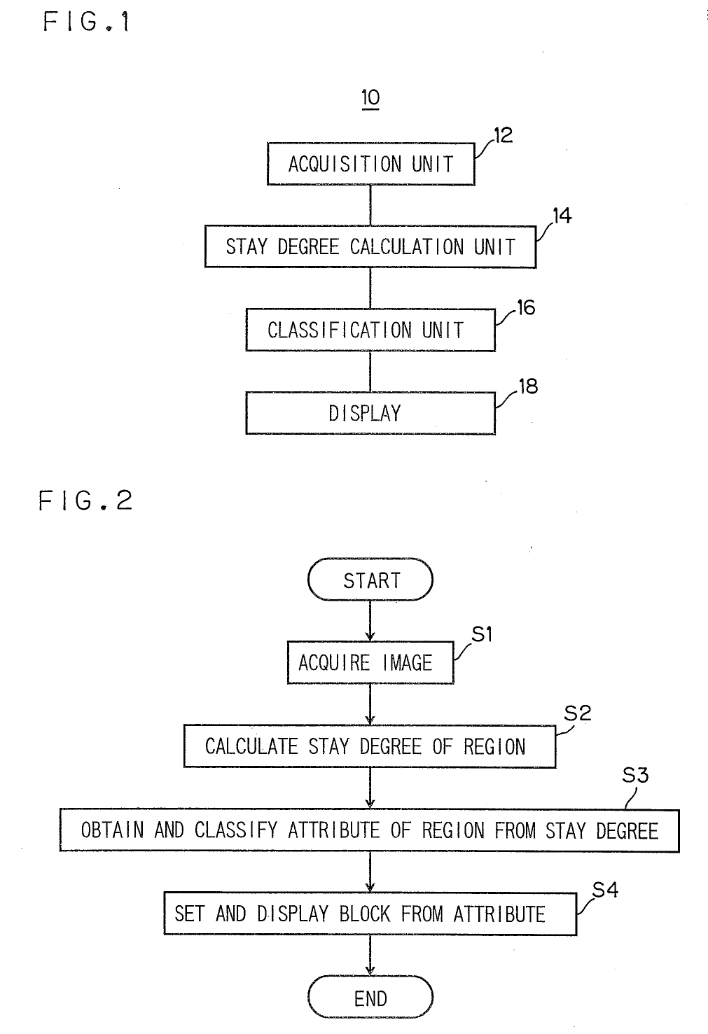

Hereinafter, a crowd classifying apparatus 10 of a first embodiment will be described with reference to FIGS. 1 to 10.

The configuration of the crowd classifying apparatus 10 will be described based on a block diagram of FIG. 1. The crowd classifying apparatus 10 includes an acquisition unit 12, a stay degree calculation unit 14, a classification unit 16 and a display 18.

An operation state of the crowd classifying apparatus 10 will be described based on a flow chart of FIG. 2.

At Step S1, the acquisition unit 12 acquires a time-series image, which is obtained by photographing crowd, from the image acquisition device 22.

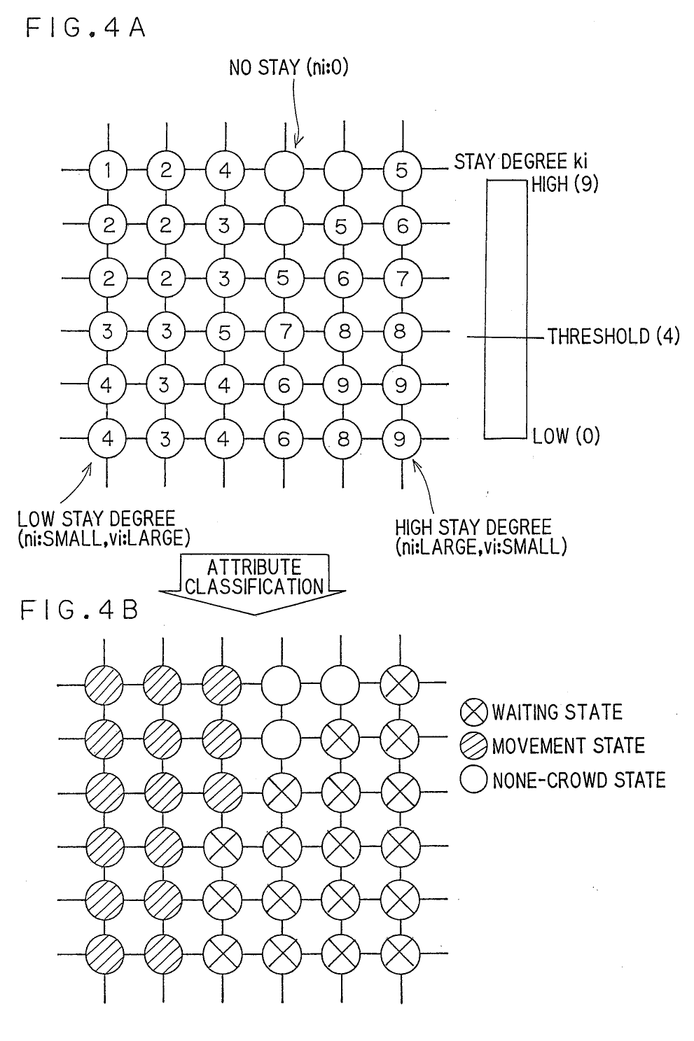

At Step S2, the stay degree calculation unit 14 calculates a stay degree ki of crowd for each region i from the time-series image output from the acquisition unit 12. In the drawings, one circle represents one region. However, since multiple colors cannot be expressed in the drawings, the stay degree ki is indicated by numerals 0 to 9, rather than colors. In this case, a larger numeral indicates more persons who stop. For example, in FIG. 4A, a numeral written in a circle indicates the stay degree ki. However, this numeral is just an example of the stay degree ki.

At Step S3, based on the stay degree ki of crowd, the classification unit 16 classifies each region i into one of plural attributes. Since the kinds of attributes cannot be expressed by color in the drawings, the attributes are expressed by X mark, hatching or white color, rather than color. For example, in FIG. 4B, an attribute of “waiting” is expressed by X mark, an attribute of “moving” is expressed by hatching, and an attribute of “none crowd” is expressed by white color. However, these expressions are just examples of the stay degree ki.

At Step S4, the display 18 sets and displays a block consisting of one or more regions occupied by the same attribute.

The acquisition unit 12 acquires the time-series image obtained by photographing the crowd from the image acquisition device 22. The image acquisition device 22 is, e.g., a camera with a CMOS image sensor, an infrared image sensor, a range image sensor or a video player.

The stay degree calculation unit 14 calculates the stay degree of crowd from the time-series image output from the acquisition unit 12. The term “stay degree” refers to a value indicating the number of crowd per unit area and the size and direction of motion of crowd. Therefore, the stay degree calculation unit 14 obtains the number of crowd per unit area, obtains the size and direction of motion of crowd, and then calculates the stay degree per unit area from the obtained number of crowd and the obtained size and direction of motion of crowd. A larger stay degree indicates more stopping crowds per unit area.

The term “unit area” refers to one pixel of an image, the number of pixels in one grid when an image is divided into grids, the area (m²) of one grid when the real space is divided into grids, or the size of one partial space when a space is manually divided into partial spaces. In the following description, a space divided for unit area will be referred to as a “region.” In the drawings, one region is indicated by one circle.

Examples of a region defined by the stay degree calculation unit 14 will be described below.

As a first example, the stay degree calculation unit 14 defines a region as each pixel of an image and represents the size of the region by one pixel and the position of the region by a xy coordinate of a pixel.

As a second example, the stay degree calculation unit 14 defines a region as each grid when an image is divided into grids, and represents the size of the region by the number of pixels in one grid and the position of the region by a xy coordinate of the center of a grid.

As a third example, the stay degree calculation unit 14 defines a region as each grid when the real space is divided into grids, and represents the size of the region by the area (m²) of one grid and the position of the region by a XYZ coordinate (world coordinate) (m) when an intersection of an optical axis of a camera and a ground is assumed as the coordinate center, a north direction is assumed as a Y axis, an east direction is assumed as an X axis and a sky direction is assumed as a Z axis.

The following equations (1) and (1)′ are used for transformation between the XYZ coordinate and the pixel xy coordinate.

$$\begin{matrix}[ Eq . 1 ] & \\ s [ \begin{matrix}x \\ y \\ 1\end{matrix} ] = A [ R \vert t ] [ \begin{matrix}X \\ Y \\ Z \\ 1\end{matrix} ] & ( 1 ) \\ A = [ \begin{matrix}{f}_{x} & 0 & {c}_{x} \\ 0 & {f}_{y} & {c}_{y} \\ 0 & 0 & 1\end{matrix} ] , & ( 1 )\end{matrix}$$

Where, fx and fy represent a focal length in the unit of pixel, cx and cy represent the central position of an image, s represents a value used to scale all parameters, and [R|t] represents an matrix for rotation and translation. Each parameter is estimated by camera calibration or the like using a checkerboard.

Examples of a method of counting the number of crowd for each region by the stay degree calculation unit 14 will be described below.

As a first example, the stay degree calculation unit 14 has a feature extractor and a face detector. First, the feature extractor extracts a feature, such as an edge, a luminance difference or the like, from an image. Next, the face detector discriminates an object between a face and a non-face by statistically learning the extracted feature, and counts the number of times by which the object is discriminated as the face, for each region.

As a second example, the stay degree calculation unit 14 has a feature extractor and a person detector. First, the feature extractor extracts a feature, such as an edge, a luminance difference or the like, from an image. Next, the person detector discriminates an object between a person and a non-person by statistically learning the extracted feature and counts the number of times by which the object is discriminated as the person, for each region.

As a third example, the stay degree calculation unit 14 has a feature extractor and a number-of-person detector. First, the feature extractor extracts a feature, such as an edge, a luminance difference or the like, from an image. Next, the number-of-person detector calculates the number of persons for each region by statistically learning the extracted feature.

Examples of a method of calculating the size and direction of motion of crowd for each region by the stay degree calculation unit 14 will be described below.

As a first example, the stay degree calculation unit 14 calculates the size and direction of motion of crowd for each region by an optical flow.

As a second example, the stay degree calculation unit 14 tracks a result of face or person detection through template-matching between time-series images and calculates the size and direction of motion of crowd for each region from the size and direction of movement of the template.

Examples of a method of calculating the stay degree ki for each region i by the stay degree calculation unit 14 will be described below.

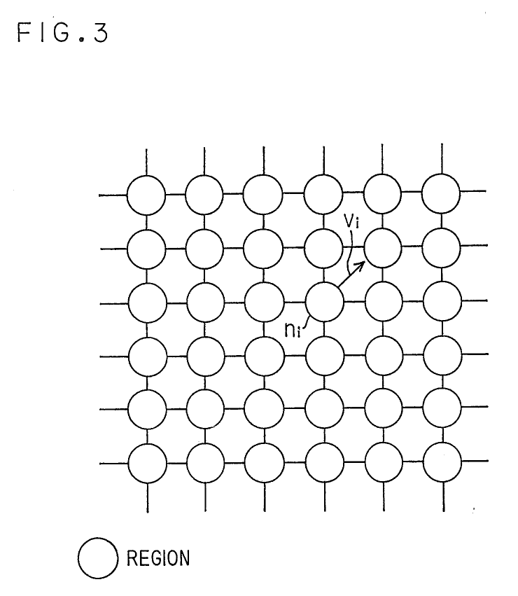

As a first example, the stay degree calculation unit 14 calculates the stay degree ki of a region i using the following equation (2), as illustrated in FIG. 3. Here, ni represents the number of crowd, vi represents the size of motion of crowd, si represents the size of a region i, v represents a small value to prevent 0 division, and w0 represents s weight parameter.

$$\begin{matrix}[ Eq . 2 ] & \\ {k}_{i} = {w}_{0} \frac{{n}_{i}}{{v}_{i} {s}_{i} + v} & ( 2 )\end{matrix}$$

As a second example, the stay degree calculation unit 14 calculates the stay degree ki of a region i using the following equation (3). Here, w1 and w2 represent a weight parameter.

$$\begin{matrix}[ Eq . 3 ] & \\ {k}_{i} = {w}_{0} {n}_{i} + {w}_{1} \frac{1}{{v}_{i} + v} + {w}_{2} \frac{1}{{s}_{i}} & ( 3 )\end{matrix}$$

As a third example, the stay degree calculation unit 14 calculates the stay degree ki based on a particular position from the following equation (8) or (9) obtained by adding a bias bpos depending on a distance to the particular position to the above equation (3).

A first method of calculating the bias bpos is to calculate the bias bpos from the following equation (4) where xi and yi represent a region position and xj and yj represent a particular position.

$$\begin{matrix}[ Eq . 4 ] & \\ {b}_{pos} = \frac{1}{\sqrt{{( {x}_{i} - {x}_{j} )}^{2} + {( {y}_{i} - {y}_{j} )}^{2} + 1}} & ( 4 )\end{matrix}$$

A second method of calculating the bias bpos is to calculate the bias bpos from the following equation (5).

$$\begin{matrix}[ Eq . 5 ] & \\ {b}_{pos} = \frac{1}{\vert {x}_{i} - {x}_{j} \vert + \vert {y}_{i} - {y}_{j} \vert + 1} & ( 5 )\end{matrix}$$

A third method of calculating the bias bpos is to calculate the bias bpos from the following equation (6). This method is applied to a case where the particular position is expressed by the world coordinate in which a position of a region i is expressed by (Xi, Yi, Zi) and a particular position is expressed by (Xj, Yj, Zj).

$$\begin{matrix}[ Eq . 6 ] & \\ {b}_{pos} = \frac{1}{\sqrt{{( {X}_{i} - {X}_{j} )}^{2} + {( {Y}_{i} - {Y}_{j} )}^{2} + {( {Z}_{i} - {Z}_{j} )}^{2}} + 1} & ( 6 )\end{matrix}$$

A fourth method of calculating the bias bpos is to calculate the bias bpos from the following equation (7).

$$\begin{matrix}[ Eq . 7 ] & \\ {b}_{pos} = \frac{1}{\vert {X}_{i} - {X}_{j} \vert + \vert {Y}_{i} - {Y}_{j} \vert + \vert {Z}_{i} - {Z}_{j} \vert + 1} & ( 7 )\end{matrix}$$

Using the bias bpos calculated from the equations (4) to (7), the stay degree ki is calculated from the equation (8) or (9). In the equation (8), wpos represents a weight to determine the magnitude of an influence of the bias.

$$\begin{matrix}[ Eq . 8 ] & \\ {k}_{i} = {w}_{0} \frac{{n}_{i}}{{v}_{i} {s}_{i} + v} + {w}_{pos} {b}_{pos} & ( 8 ) \\ [ Eq . 9 ] & \\ {k}_{i} = {w}_{0} \frac{{n}_{i}}{{v}_{i} {s}_{i} + v} + {b}_{pos} & ( 9 )\end{matrix}$$

As described above, in the third example, for example by increasing a weight (bias bpos) of crowd close to a particular exhibit in an exhibition and decreasing a weight (bias bpos) of crowd distant from the particular exhibit, the stay degree calculation unit 14 may calculate a larger stay degree ki only for crowd close to the exhibit.

In addition, in front of an elevator, by increasing a weight of crowd close to the elevator and decreasing a weight of crowd distant from the elevator, the stay degree calculation unit 14 may calculate a stay degree ki to distinguish between a person waiting for the elevator and a person who pauses for any other purpose.

As a fourth example, the stay degree calculation unit 14 calculates the stay degree ki to classify crowd into persons who are moving in a particular direction and other persons by adding a bias bori depending on a direction of movement of crowd to the above equation (3).

The bias bori is calculated from the following equation (10). Here, of represents a direction of movement of crowd in a region and of represents a particular direction.

$$\begin{matrix}[ Eq . 10 ] & \\ {b}_{ori} = \frac{cos ( {o}_{i} - {o}_{j} ) + 1}{2 {v}_{i} + v} & ( 10 )\end{matrix}$$

The stay degree ki is calculated from the following equation (11) or (12). Here, wori represents a weight to determine the magnitude of an influence of the bias.

$$\begin{matrix}[ Eq . 11 ] & \\ {k}_{i} = {w}_{0} \frac{{n}_{i}}{{v}_{i} {s}_{i} + v} + {w}_{pos} {b}_{ori} & ( 11 ) \\ [ Eq . 12 ] & \\ {k}_{i} = {w}_{0} \frac{{n}_{i}}{{v}_{i} {s}_{i} + v} + {b}_{ori} & ( 12 )\end{matrix}$$

As described above, in the fourth example, the stay degree calculation unit 14 calculates the stay degree ki of crowd moving in a particular direction for each region i. For example, for a vending machine in a platform of a station, the stay degree calculation unit 14 may calculate a stay degree ki to classify crowd into persons waiting in front of the vending machine and persons waiting for riding.

The classification unit 16 classifies a region i into one of plural attributes according to the stay degree ki. Examples of the attributes may include a waiting state (stop state), a moving state, a non-crowd state and so on. Specifically, the classification unit 16 makes classification with the following cases.

For an exhibition, classification may be made with the following cases. A first case is a case where, even when there are few persons around the exhibit, since the all persons wait for an explanation (a waiting state), it takes a time for the persons to receive the explanation. A second case is a case where, even when there are many persons around the exhibit, since most of the persons just pass by the exhibit (a moving state), it takes little time for the persons to receive an explanation.

For a station platform, classification may be made with the following cases. A first case is a case where, even when many persons exist near a train door, most of the persons are just moving through the station platform (a moving state) and few persons are lined up to wait for riding. A second case is a case where, even when few persons exist near the train door, all of the persons are lined up to form a long row (a waiting state).

In front of an elevator, classification may be made with the following cases. A first case is a case where, even when many persons exist near the elevator, since most of the persons just pass by the elevator (a moving state), there are few persons waiting for the elevator. A second case is a case where, even when few persons exist near the elevator, since all of the persons wait for the elevator (a waiting state), the elevator is likely to be crowded.

There are the following methods of classifying the above cases into attributes by the classification unit 18.

A first classifying method is as follows. As illustrated in FIGS. 4A and 4B, the classification unit 18 classifies a region i based on determination on whether or not the stay degree ki exceeds a threshold. For example, the classification unit 18 classifies the region i into an attribute of “waiting state” when the number of crowd ni of the region i is equal to or more than a first threshold thn and the stay degree ki is equal to or more than a second threshold thk, an attribute of “moving state” when ni is equal to or more than the first threshold thn and the stay degree ki is less than the second threshold thk, and an attribute of “none-crowd state” otherwise.

A second classifying method is as follows. The classification unit 18 classifies an attribute of a region i based on determination on whether or not a weighted sum of a stay degree ki of a region i to be classified and a stay degree k(i+1) of a region i+1 adjacent to the region i to be classified exceeds a threshold.

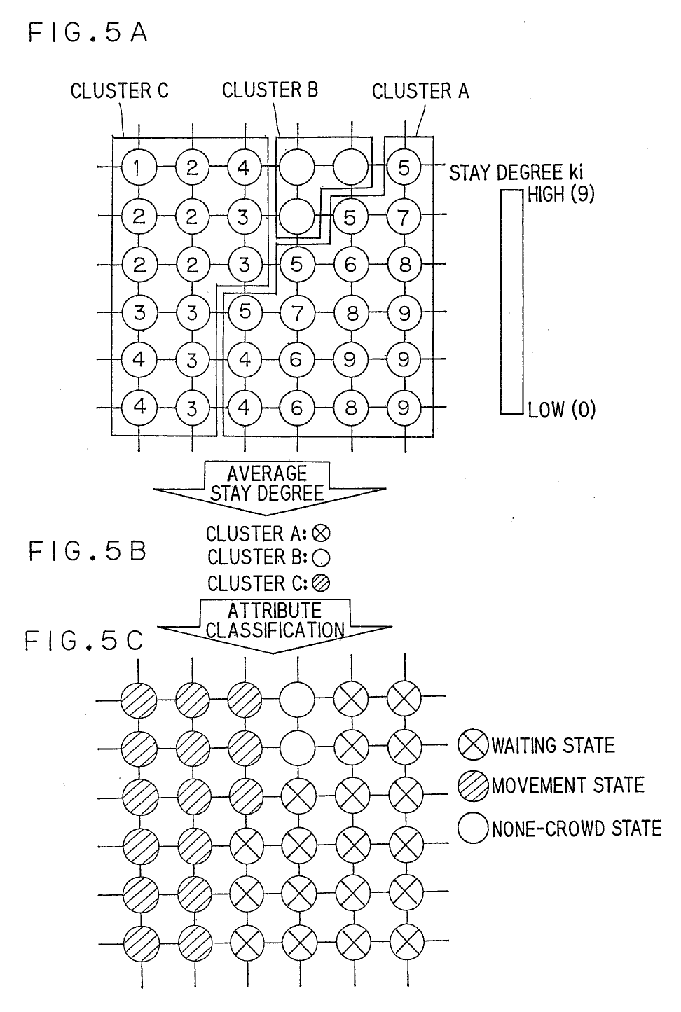

A third classifying method is as follows. As illustrated in FIGS. 5A, 5B, and 5C, the classification unit 18 clusters a stay degree ki of each region i using Mean-shift or k-means (see FIG. 5A), calculates a mean value of stay degrees ki of regions i in a cluster (see FIG. 5B), and makes classification based on determination whether or not the calculated mean value exceeds a threshold (see FIG. 5C).

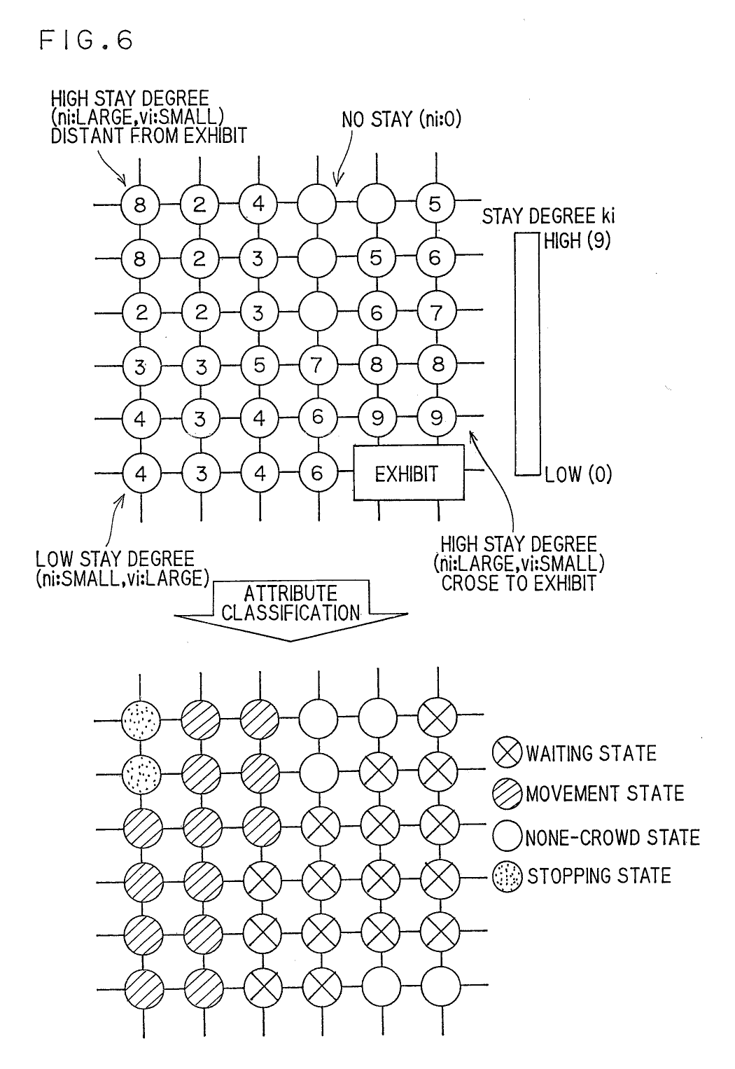

A fourth classifying method is as follows. As illustrated in FIGS. 6A and 6B, the classification unit 18 uses a distance d between a position of a region i and a particular position, in addition to the stay degree ki, to change a method of classifying the region i. For example, the classification unit 18 classifies the region i into an attribute of “waiting state” when the stay degree ki of the region i is equal to or more than the second threshold thk and the distance d is less than a third threshold thd and an attribute of “stop state” when the stay degree ki is equal to or more than the second threshold thk and the distance d is equal to or more than the third threshold thd. Accordingly, for example, for an exhibition, the classification unit 18 may make classification between persons waiting for explanation close to a particular exhibit (a waiting state) and persons waiting for explanation close to other exhibits (stop state). For a station platform, the classification unit 18 may make classification between persons waiting for riding near a train door (a waiting state) and persons waiting for a vending machine near the vending machine (a stop state). In front of an elevator, the classification unit 18 may make classification between persons waiting for the elevator (a waiting state) and persons who stop to watch a floor guide map (a stop state).

A fifth classifying method is as follows. The classification unit 18 uses a movement direction of crowd, in addition to the stay degree ki of the region i, to change a classifying method. For example, the classification unit 18 classifies the region i into an attribute of “moving state A” when the stay degree ki of the region i is less than the second threshold thk and a difference between a movement direction oi of crowd and a particular direction oj is less than a fourth threshold tho and an attribute of “moving state B” when the stay degree ki is less than the second threshold thk and the difference between oi and oj is equal to or more than the fourth threshold tho. Accordingly, for example, for an exhibition, the classification unit 18 may make classification between persons to enter (a moving state A) and persons to exit (a moving state B). For a station platform, the classification unit 18 may make classification between persons to get in (a moving state A) and persons to get off (a moving state B). For an elevator, the classification unit 18 may make classification between persons to get in (a moving state A) and persons to get off (a moving state B).

The display 18 sets and displays a block from the region i. The display 18 is, e.g., a display of a portable mobile terminal such as a smartphone or a tablet, or a fixed display such as a digital signage.

The block represents a range occupied by the same attribute and the display 18 sets the block byway of examples, as follows.

As a first example, the block is a region i.

As a second example, the block is a range obtained by clustering the stay degree ki of each region i using Mean-shift or k-means.

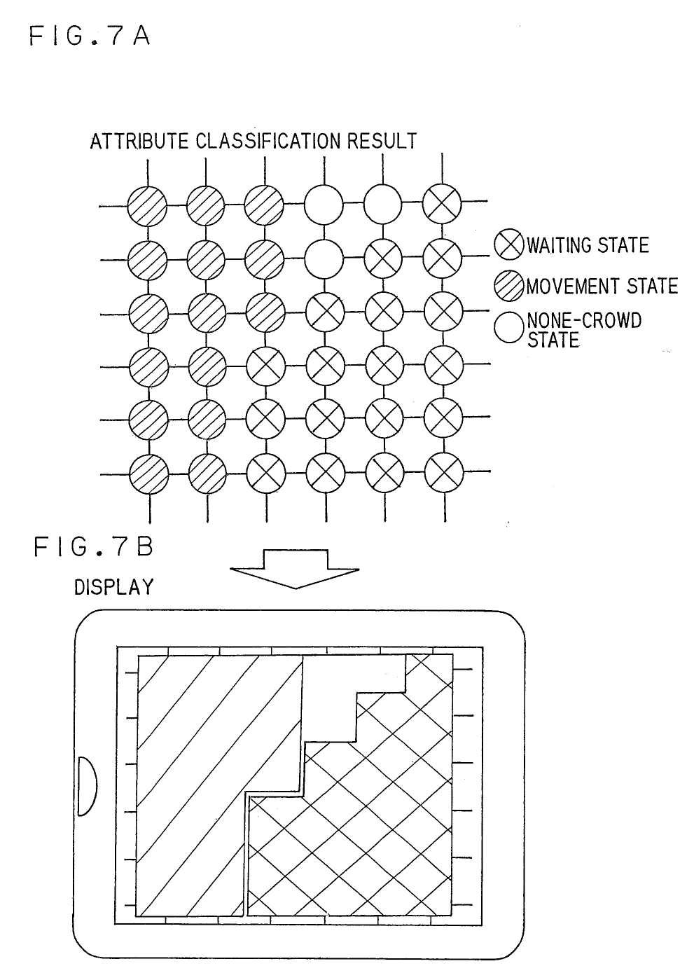

As a third example, as illustrated in FIG. 7A, the block includes plural regions which are closer than a predetermined reference distance of adjacent regions and are obtained by combining plural regions having the same attribute. Accordingly, as illustrated in FIG. 7B, a user may simply grasp a spread state of crowd waiting for explanation through the display 18.

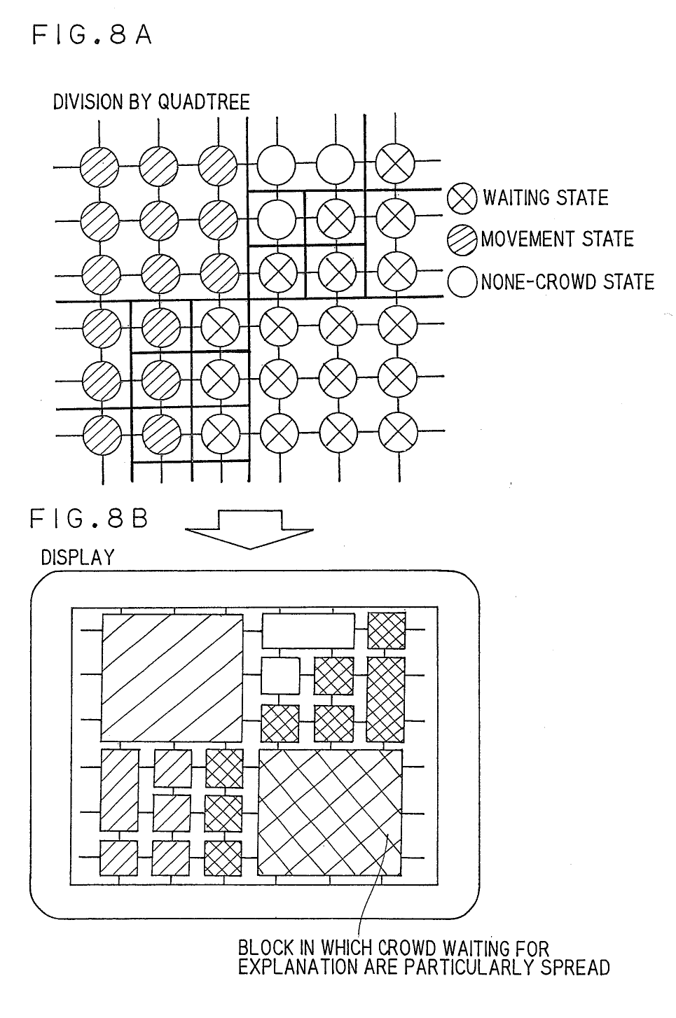

As a fourth example, as illustrated in FIG. 8A, the block is one obtained by dividing a region into blocks using Quadtree. Accordingly, as illustrated in FIG. 8B, a user may simply grasp a range in which crowd waiting for explanation is spread, through the display 18. In addition, a graph cut may be used instead of the Quadtree.

Examples of a displaying method by the display 18 will be described below.

As a first example, the display 18 changes a color according to an attribute of a block. In the drawings, since the attributes cannot be distinguished by color, the attributes of blocks are expressed by white color, hatching or cross-hatching.

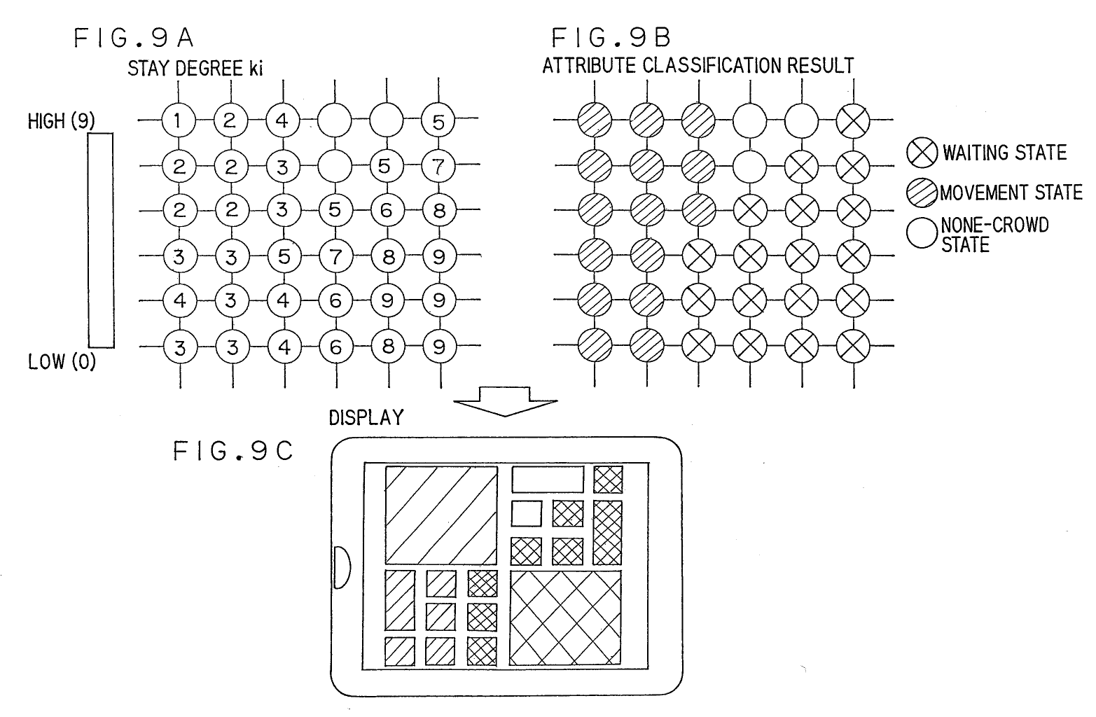

As a second example, as illustrated in FIGS. 9A, 9B and 9C, the display 18 changes the concentration of color depending on the total sum of stay degrees ki of blocks or the total sum of persons in the blocks and displays stay degrees in addition to the attributes of crowd. In the figures, the stay degree ki is expressed by numerals rather than colors.

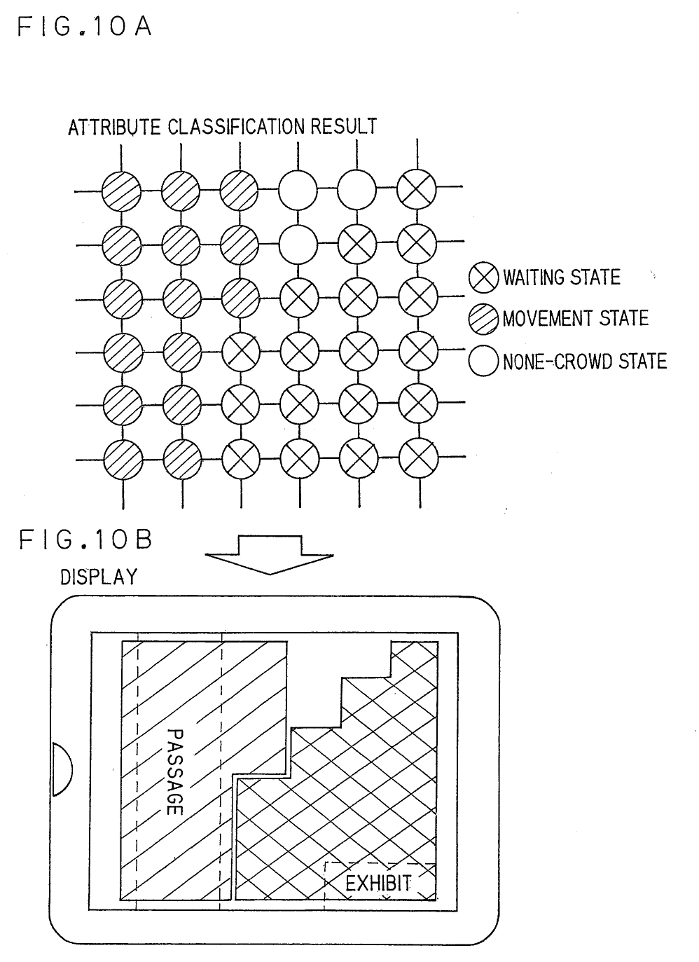

As a third example, as illustrated in FIGS. 10A and 10B, the display 18 superimposes a map such as a guide map on blocks and displays attribute results of crowd and the map at once.

According to the present embodiment, by calculating a block based on an attribute of a region i, crowd having different attributes do not exist in the same block. Accordingly, while watching contents displayed on the display 18, a user may know whether crowd near a particular position are waiting for explanation or just are passing by, how crowd waiting for explanation are spread, etc.

### Second Embodiment

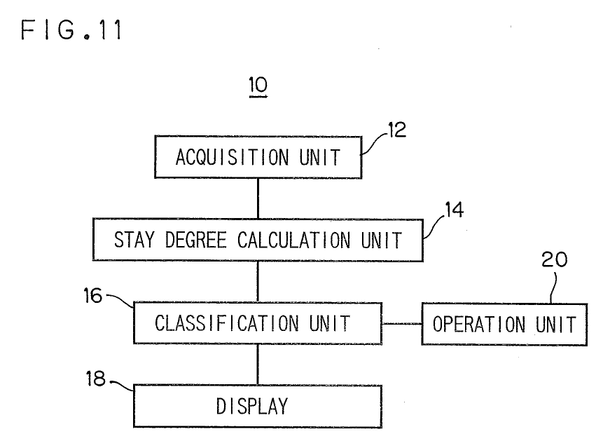

Next, a crowd classifying apparatus 10 of a second embodiment will be described with reference to FIGS. 11 to 14. The crowd classifying apparatus 10 of the present embodiment switches between an attribute classifying method and a block displaying method according to a user operation.

The crowd classifying apparatus 10 of the present embodiment further includes an operation unit 20 in addition to the acquisition unit 12, the stay degree calculation unit 14, the classification unit 16 and the display 18 as illustrated in FIG. 11. The operation unit 20 is a touch type display, a touch panel, a mouse or a touch pen.

For a building displayed on the display 18, there may be a case where it consists of plural stories, a case where it is divided in plural separate rooms, a case where a range of the building is very wide, etc. In these cases, when the entire building is displayed in a list, it is difficult for a user to grasp congest situations. Therefore, the user determines whether to see details of a particular room, a particular station platform or a chosen range or to see the overall appearance of an exhibition hall or a station or the appearance of the overall range and chooses one of them through the operation unit 20. The term “chosen range” refers to a predetermined range. The number of chosen ranges may be one or more and individual chosen ranges may have a common portion. Therefore, a range the user wants to see may be selected through the operation unit 20, thereby facilitating the situational awareness by the user.

Examples of the operation unit 20 will be described below.

As a first example, when the operation unit 20 is a touch type display, the overall appearance may be selected when the user pinches the display in. In addition, when the user pinches a desired chosen range on the display out, the chosen range may be selected.

As a second example, when the operation unit 20 is a mouse, the overall appearance may be selected when the user right-clicks the mouse. In addition, when the user left-clicks the mouse on a chosen range the user wants to watch, the chosen range may be selected.

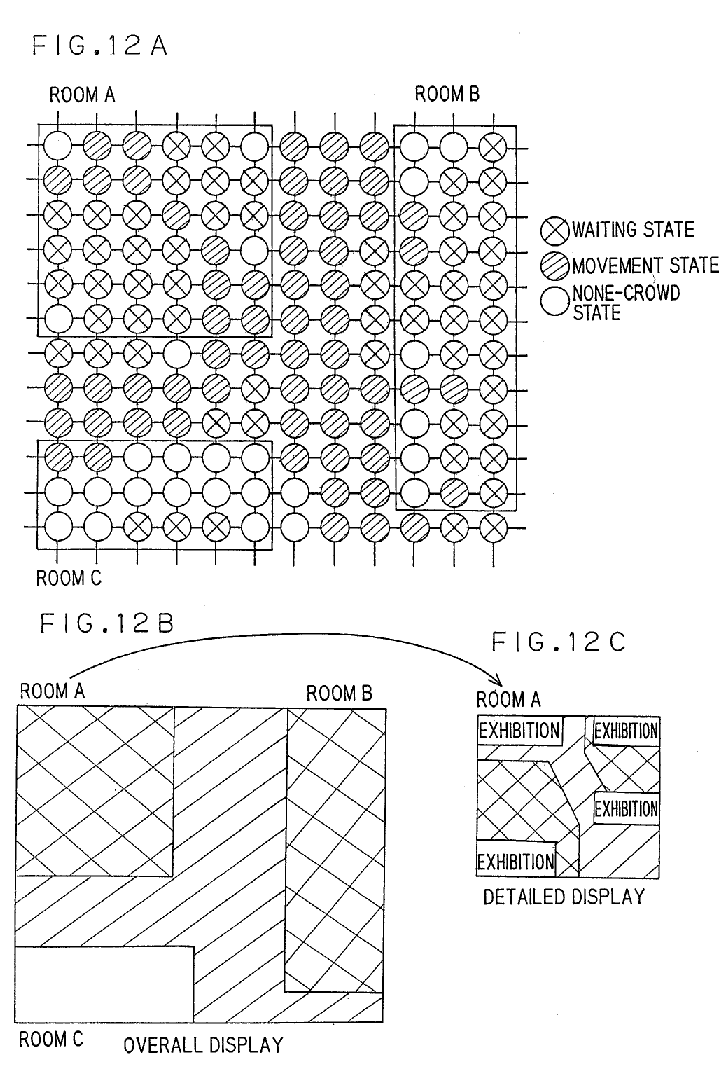

As illustrated in FIG. 12, when the user chooses a chosen range, e.g., a room A (see FIG. 12C) as a target to watch, from the overall display (see FIG. 12B) through the operation unit 20, each region in the chosen range is divided into blocks (see FIG. 12A). When the user chooses the overall appearance through the operation unit 20 as a target to watch, each chosen range is divided into blocks. Thus, a range the user wants to watch may be displayed.

For block division for each chosen range, the classification unit 16 is required to classify the attributes of the chosen range. How to classify is as follows.

As a first classifying method, the classification unit 16 takes a majority of attributes in a region in the chosen range and classifies an attribute having the greatest number of regions as an attribute of the chosen range.

As a second classifying method, the classification unit 16 takes a majority of attributes in a region in the chosen range as a weight of a stay degree ki and classifies an attribute having the highest weight as an attribute of the chosen range. In addition, when the display of the display 18 has the overall appearance, since the method of classifying the attributes of the region is changed depending on the chosen range, the classification unit 16 changes the attributes of the chosen ranges determined by a majority of attributes of a region in the chosen range.

The display 18 displays a chosen range or the overall appearance. When detailed appearance in the chosen range is to be seen, the display 18 distinguishes and displays colors for each region. In addition, when the overall appearance is to be seen, the display 18 distinguishes colors for each attribute in the chosen range. In addition, since coloring cannot be described in the figures, the blocks are expressed by hatching or cross-hatching.

As a first example, since the overall region is classified into attributes as illustrated in FIG. 12A, the display 18 displays the overall attributes of rooms A to G as illustrated in FIG. 12B and the user sees a chosen range (a particular room) from the display, a chosen range (room A) is selected through the operation unit 20. Then, as illustrated in FIG. 12C, the display 18 displays a superposition of detailed attributes of each region in the chosen range (room A) on a guide map.

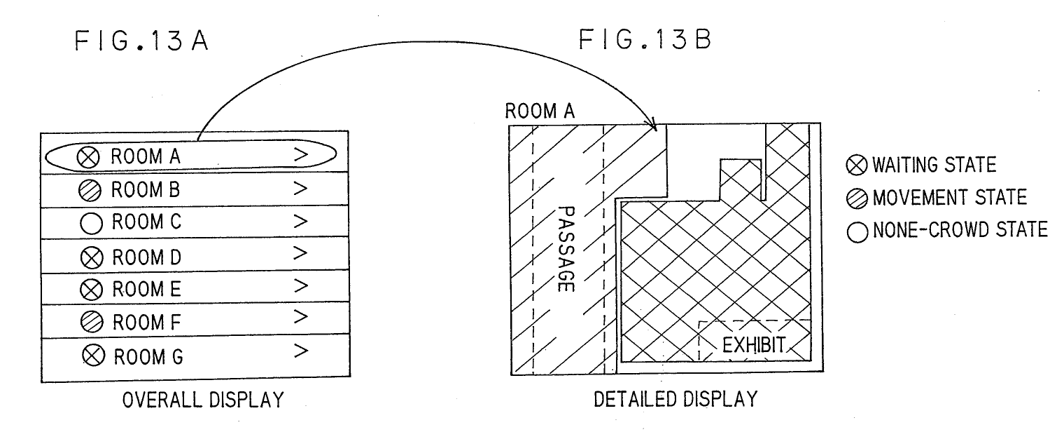

As a second example, the display 18 may display overall attributes of rooms in the form of a table as illustrated in FIG. 13A.

As a third example, when the user chooses the overall appearance through the operation unit 20 to see the appearance, the display 18 displays the attribute of the chosen range with an icon, thereby facilitating check of all chosen ranges and check of details of a chosen range even in a limited size screen.

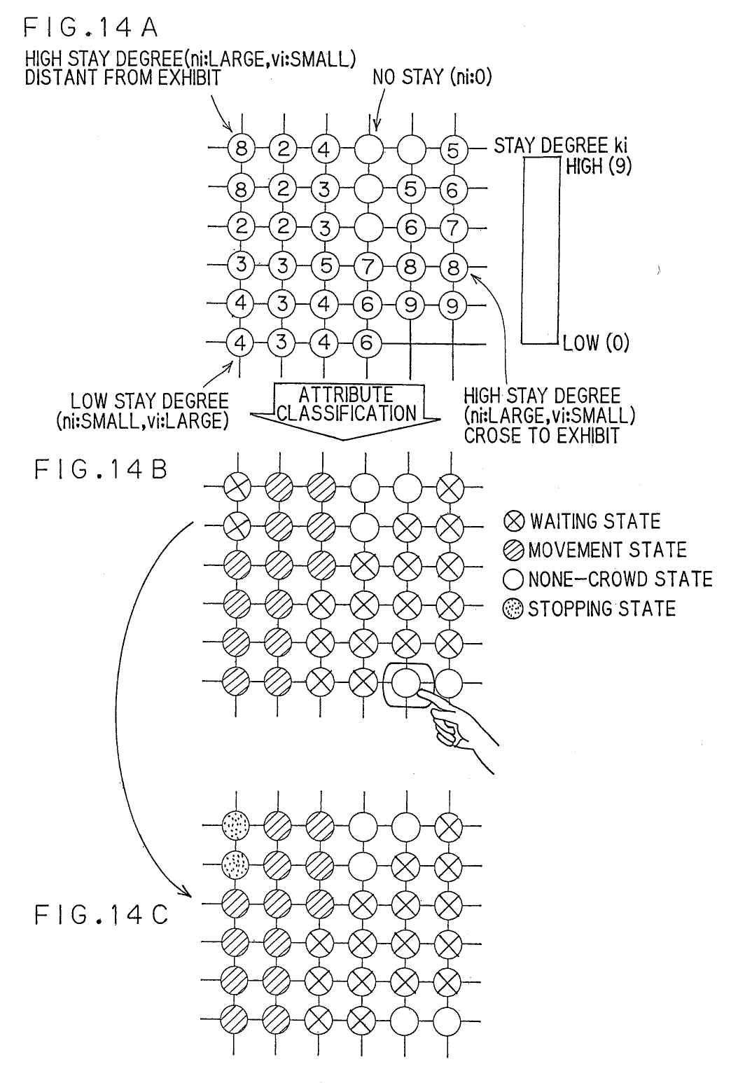

As a fourth example, the user chooses his own aimed chosen range through the operation unit 20. The choice of the chosen range through the operation unit 20 is made by touching the touch-type display or mouse clicking. The classification unit 16 changes the method of classifying the region attributes based on the chosen range chosen by the user. The display 18 displays and feeds back the chosen position to the user so that he knows the selection. The choice by the user is sequentially made and contents displayed on the display 18 are changed every choice. For example, classification on whether persons in the same staying state are intentionally waiting or are in other states in the chosen range is made, and a result of the classification is changed to an attribute of a waiting state or an attribute of a stopping state depending on positions of persons in the chosen range. For an exhibition hall, when the user chooses the vicinity of a particular exhibit, the classification unit 16 classifies only persons staying in the vicinity of the exhibit as the waiting state and classifies persons staying in other places as the stopping state. Thus, the user may check persons waiting for explanation in the particular exhibit. For example, as illustrated in FIG. 14A, when the user does not choose any chosen range, the classification unit 16 classifies attributes based on only a stay degree ki, in the same way as in the above-described embodiment. In addition, when the user chooses a chosen range through the operation unit 20 (see FIG. 14B), the classification unit 16 classifies attributes based on a distance between a region position and the chosen range, in addition to the stay degree ki (see FIG. 14C). The classifying method using only the stay degree ki employs the equations (2) and (3). The classifying method additionally using the distance between the region position and the chosen range employs the equations (8) and (9).

As a modification of the present embodiment, an exhibit the user wants to watch is chosen through the operation unit 20 and a visit time may be estimated by calculating a waiting time from a stay degree ki and an attribute of a block close to the chosen exhibit. The waiting time (a time for which visitors are stopping) can be calculated with the stay degree ki as an input by pre-performing a mechanical learning associating the stay degree ki and the waiting time.

### Third Embodiment

Next, a crowd classifying apparatus 10 of a third embodiment will be described. The crowd classifying apparatus 10 of the present embodiment may display, on the display 18, the minimum time taken for sequential movement between plural particular positions to allow the user to check the minimum time.

For an exhibition, the particular positions mean exhibition positions of plural exhibits and it takes a visit time for visitors to stop by the exhibits. The term “visit time” used herein refers to the total time of waiting time+exhibit appreciation time+movement time. The term “waiting time” is calculated with the stay degree ki as an input by pre-performing a mechanical learning associating the stay degree ki of each exhibit and the waiting time (the time for which visitors are stopping). The term “exhibit appreciation time” refers to a time preset for each exhibit. The term “movement time” refers to a time taken for the visitors to move between plural particular positions (exhibits). The movement time between the plural particular positions is set in advance.

The crowd classifying apparatus 10 calculates the current visit time. The current visit time is calculated by calculating a waiting time from the current stay degree ki, as described above, and adding an appreciation time and a movement time to the waiting time. In addition, the crowd classifying apparatus stores the visit time calculated for each exhibit as described above, every time. The stored visit time becomes a past visit time.

The crowd classifying apparatus 10 uses the past visit time and the current visit time to calculate a predicted value of a later visit time. As a method of calculating the predicted value, a visit time at a particular timing in future is predicted by applying and fitting any model to a temporal change of visit time up to now. As another calculating method, a change in stay degree ki for each block is predicted from a change in the number of persons, a distance between blocks and an average movement speed of persons.

When plural particular positions exist, visit routes exist as the factorial of the number of particular positions in combination. When a start position is assumed as a predetermined position or a current particular position, the crowd classifying apparatus 10 calculates a visit route to be visited with the minimum time by solving an optimization problem to minimize a movement time and a predicted visit time after the movement, and displays the calculated visit route on the display 18. In addition, the crowd classifying apparatus 10 may use a dynamic programming to calculate a visit route, which may be visited with the minimum time, in a realistic computation time. In addition, an evaluation function to select whether to move from which particular position to which particular position may be used to select a particular position providing the minimum of sum of a time of movement to a movement destination and a predicted visit time after the movement time.

In addition, the display 18 may not only calculate a visit route to be visited with the minimum time when moved through all particular positions but also display a visit route to be visited with the minimum time in plural chosen ranges chosen by the user through the operation unit 20.

In addition, when plural users share one display such as a digital signage or the like, the display 18 displays a particular position of the next movement destination obtained by the above-described evaluation function.

While certain embodiments have been described, these embodiments have been presented byway of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An apparatus for classifying crowd, comprising:
processing circuitry configured to:
acquire a time-series image including the crowd;
divide the image into a plurality of regions and calculate a stay degree for each of the regions based on a number of persons in one of the regions and size and direction of motion of persons in one of the regions, wherein the stay degree has a higher value for more stopping persons in one of the regions; and
classify each of the regions according to the stay degree as one of an attribute indicating that the crowd are stopping in the region, an attribute indicating that the crowd are moving in the region, and an attribute indicating that no crowd exists in the region; and
a display configured to:
set a range occupied by one or more regions having a same attribute as one block and display the block while expressing the attribute.

2. The apparatus according to claim 1, wherein the display is further configured to:
set a range combining plural regions, which are closer than a predetermined reference distance and are classified as the same attribute, as the one block.

3. The apparatus according to claim 1, wherein the processing circuitry is further configured to:
determine whether or not the number of persons in the region exceeds a predetermined first threshold, determine whether or not the stay degree of the region exceeds a predetermined second threshold, assign the region with the attribute indicating that the crowd are stopping in the region when the number of persons is higher than the first threshold and the stay degree is higher than the second threshold, and assign the region with the attribute indicating that the crowd are moving in the region when the number of persons is higher than the first threshold and the stay degree is lower than the second threshold.

4. The apparatus according to claim 1, wherein the processing circuitry is further configured to:
obtain a class by clustering the regions using the stay degree and assign the attribute to the class.

5. The apparatus according to claim 1, wherein the processing circuitry is further configured to:
change the classification of the attributes according to a distance between the region and a predetermined particular position.

6. The apparatus according to claim 1, wherein the processing circuitry is further configured to:
calculate a higher stay degree for a region closer to the predetermined particular position.

7. The apparatus according to claim 1, wherein the processing circuitry is further configured to:
calculate a higher stay degree for a movement direction of persons in the region closer to a predetermined particular direction.

8. The apparatus according to claim 1, further comprising:
an operation unit configured to select a partial range of the image displayed on the display as a chosen range,
wherein, when the chosen range is displayed in extension or reduction, the operation unit changes the display of the attribute expressed in the block according to the chosen range.

9. The apparatus according to claim 1, further comprising:
an operation unit configured to select the block on the image displayed on the display,
wherein the display calculates a stopping time of the crowd in the selected block from the stay degree.

10. The apparatus according to claim 1, further comprising:
an operation unit configured to select the block on the image displayed on the display,
wherein the display displays the block to be moved from a predetermined position or the current position to the next position such that the stopping time of the crowd in two or more selected blocks becomes minimal.

11. A method for classifying crowd, comprising:
acquiring a time-series image including the crowd;
dividing the image into a plurality of regions and calculating a stay degree for each of the regions from a number of persons in one of the regions and size and direction of motion of persons in one of the regions, wherein the stay degree has a higher value for more stopping persons in one of the regions;
classifying each of the regions according to the stay degree as one of an attribute indicating that the crowd are stopping in the region, an attribute indicating that the crowd are moving in the region and an attribute indicating that no crowd exist in the region; and
setting a range occupied by one or more regions having a same attribute as one block and displaying the block while expressing the attribute.

12. The method according to claim 11, wherein
the setting sets a range combining plural regions, which are closer than a predetermined reference distance and are classified as the same attribute, as the one block.

13. The method according to claim 11, further comprising:
determining whether or not the number of persons in the region exceeds a predetermined first threshold, determining whether or not the stay degree of the region exceeds a predetermined second threshold, assigning the region with the attribute indicating that the crowd are stopping in the region when the number of persons is higher than the first threshold and the stay degree is higher than the second threshold, and assigning the region with the attribute indicating that the crowd are moving in the region when the number of persons is higher than the first threshold and the stay degree is lower than the second threshold.

14. The method according to claim 11, further comprising:
obtaining a class by clustering the regions using the stay degree and assign the attribute to the class.

15. The method according to claim 11, further comprising:
changing the classification of the attributes according to a distance between the region and a predetermined particular position.

16. The method according to claim 11, wherein
the calculating calculates a higher stay degree for a region closer to the predetermined particular position.

17. The method according to claim 11, wherein
the calculating calculates a higher stay degree for a movement direction of persons in the region closer to a predetermined particular direction.

18. The method according to claim 11, further comprising:
selecting a partial range of the displayed image as a chosen range; and
when the chosen range is displayed in extension or reduction, changing the display of the attribute expressed in the block according to the chosen range.

19. The method according to claim 11, further comprising:
selecting the block on the displayed image; and
calculating a stopping time of the crowd in the selected block from the stay degree.

20. A non-transitory program stored in a computer readable medium, causing a computer to perform a method for classifying crowd, the method comprising:
acquiring a time-series image including the crowd;
dividing the image into a plurality of regions and calculating a stay degree for each of the regions from a number of persons in one of the regions and size and direction of motion of persons in one of the regions, wherein the stay degree has a higher value for more stopping persons in one of the regions;
classifying each of the regions according to the stay degree as one of an attribute indicating that the crowd are stopping in the region, an attribute indicating that the crowd are moving in the region and an attribute indicating that no crowd exist in the region; and
setting a range occupied by one or more regions having a same attribute as one block and displaying the block while expressing the attribute.
